(19) United States
(12) Patent Application Publication
(10) Pub. No.: US 2026/0234443 A1
(43) Pub. Date: Aug. 13, 2026

(54) SILICONE FACIAL TAPE

(71) Applicant: Lili Meloul, Closter, NJ (US)

(72) Inventor: Lili Meloul, Closter, NJ (US)

(21) Appl. No.: 19/536,708

(22) Filed: Feb. 11, 2026

Related U.S. Application Data
(60) Provisional application No. 63/757,183, filed on Feb. 11, 2025.

(51) Int. Cl. C09J 7/22; C09J 7/10; C09J 7/20; C09J 7/21; C09J 7/38; C09J 7/40

(52) U.S. Cl. CPC C09J 7/22; C09J 7/10; C09J 7/20; C09J 7/21; C09J 7/38; C09J 7/401; C09J 2301/312; C09J 2433/00

(57) ABSTRACT

A silicone facial tape set designed for cosmetic skincare, particularly for reducing facial wrinkles and fine lines. The described product includes pre-cut tape pieces (10, 12, 14) made from medical-grade, skin-safe silicone, tailored for targeted wrinkle-prone areas such as the forehead, under-eyes, and smile lines. Each tape piece features an adhesive backing configured to securely adhere to the skin overnight without causing irritation or leaving residue. The second surface of the tape incorporates decorative patterns (20, 22, 24) to enhance aesthetic appeal and encourage consistent use. The tape provides gentle mechanical support to maintain skin tension, promoting smoother skin over time. The method of manufacture includes precision cutting of silicone sheets, application of skin-safe adhesives, and integration of durable decorative designs. This product offers a non-invasive, user-friendly solution for overnight wrinkle management, combining functionality, comfort, and visual appeal to improve user compliance and skincare outcomes.

### CROSS-REFERENCE TO RELATED APPLICATION

This application claims the benefit of priority of U.S. provisional application number 63/757,183, filed Feb. 11, 2025, the contents of which are herein incorporated by reference.

### BACKGROUND OF THE INVENTION

The present invention relates to cosmetic skincare and, more particularly, to silicone facial tape.

The field of cosmetic skincare has seen growing interest in non-invasive methods for managing the appearance of facial wrinkles and fine lines. Materials engineered for skin contact—such as adhesive patches, tapes, and flexible polymers—have been explored to provide mechanical support and maintain skin tension in targeted areas. These approaches fall within a broader category of wearable skincare technologies designed to interface directly with the skin's surface, combining biocompatible substrates with gentle adhesion to deliver consistent cosmetic benefits without the need for clinical procedures.

In many skincare regimens, the goal is to smooth creases and maintain a youthful appearance through gentle, continuous support of wrinkle-prone areas. Ideal solutions aim to integrate seamlessly into nightly routines, delivering subtle mechanical tension that helps prevent the formation of new creases while encouraging the reduction of existing fine lines. For such solutions to be effective, they need to balance adequate adhesion, user comfort, and visual discretion, allowing individuals to wear them for extended periods—often overnight—without disrupting sleep or daily activities. Despite numerous options on the market, current wrinkle-reduction methods often fall short of these objectives. Topical creams and serums can require repeated applications and may offer only transient effects. Injectable treatments deliver more pronounced results but are invasive, costly, and necessitate professional administration. Many mechanical devices or masks designed to hold skin taut can be bulky, rigid, or uncomfortable, making such solutions impractical for unsupervised home use. As a result, users may find maintaining consistent application schedules challenging, which can limit the effectiveness of these methods over extended periods.

Existing adhesive tapes and patches intended for overnight wrinkle management frequently suffer from poor user compliance due to comfort and aesthetic concerns. Shifting or peeling during sleep can reduce effectiveness and lead to skin irritation. Moreover, many products exhibit a bland or clinical appearance, discouraging regular use and detracting from the wearer's self-confidence. The lack of visually appealing designs and the potential for adhesive residue further diminish the appeal of these solutions.

As can be seen, there is a need for a streamlined approach that combines secure adhesion, skin compatibility, and an elegant appearance to promote consistent and effective wrinkle-reduction treatment.

### SUMMARY OF THE INVENTION

In one embodiment, a silicone facial tape set includes a plurality of tape pieces, each comprising a medical-grade, skin-safe silicone sheet pre-cut into one or more facial shapes (for example, forehead, under-eye, and smile-line pieces), an adhesive backing on the first surface configured to adhere securely to facial skin overnight without causing irritation or leaving residue, and a decorative pattern on the second surface. The adhesive backing comprises a hypoallergenic, pressure-sensitive adhesive capable of maintaining adhesion for at least eight hours, and the silicone sheet has a thickness ranging from about 0.2 mm to about 0.8 mm. The tape pieces are supplied in protective packaging designed to organize and safeguard the pieces.

In another embodiment, a method of manufacturing the silicone facial tape set comprises providing a medical-grade, skin-safe silicone sheet; cutting the sheet into a plurality of tape pieces pre-shaped for facial application using a precision cutting tool such as a laser cutter or die-cutting machine; applying a hypoallergenic, pressure-sensitive adhesive backing to the first surface of each piece; forming a decorative pattern on the second surface by screen-printing or embedded printing techniques; inspecting each tape piece for uniformity in shape, adhesive coverage, and decorative pattern alignment; and packaging the pieces in protective, hygienic packaging.

These and other features, aspects and advantages of the present invention will become better understood with reference to the following drawings, description, and claims.

### BRIEF DESCRIPTION OF THE DRAWINGS

FIG. 1 is a front elevation view of decorative silicone facial tape according to an embodiment of the present invention;

FIG. 2 is another front elevation view thereof, shown in use;

FIG. 3 is a sectional view thereof, taken along line 3-3 in FIG. 2;

FIG. 4 is a front elevation view of another embodiment of the decorative silicone facial tape; and

FIG. 5 is a front elevation view of another embodiment of the decorative silicone facial tape.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, “skin-safe” refers to a material that is biocompatible, hypoallergenic, and suitable for prolonged contact with human skin without causing irritation, sensitization, or adverse dermatological reactions.

As used herein, “medical-grade” refers to a material that meets established biocompatibility and safety standards for use in direct and prolonged contact with human tissue, such as those set forth by ISO 10993 or equivalent regulatory guidelines.

Broadly, one embodiment of the present invention is a silicone-based facial tape that combines high-quality, skin-safe materials with thoughtfully designed aesthetics to enhance user experience and promote consistent use. Unlike conventional adhesive patches, the described solution employs medical-grade silicone that adheres gently yet securely to the skin, ensuring the tape remains in place throughout the night without causing irritation or discomfort. The tape is pre-cut into shapes tailored for wrinkle-prone areas, such as the forehead, under-eyes, and smile lines, allowing for precise application and targeted wrinkle reduction. Additionally, the described product incorporates decorative patterns and designs, transforming the product from a purely functional skincare tool into an aesthetically pleasing accessory. This combination of functionality and visual appeal encourages users to integrate the product into their nightly routines, thereby improving compliance and long-term results.

The present subject matter distinguishes itself from the prior art through its unique combination of a silicone-based adhesive and a thin thermoplastic polyurethane (TPU) printing design layer functioning as a top layer. Unlike conventional face tapes that rely on pressure-sensitive adhesives formulated from materials like acrylics, rubber, or other synthetic polymers, the use of a silicone-based adhesive in this invention provides enhanced comfort, superior skin compatibility, and reduced risk of irritation, making it particularly suitable for overnight wear on sensitive facial skin. The silicone adhesive maintains a secure hold throughout the night while preserving skin health, a benefit not achieved by traditional adhesives. Additionally, the incorporation of a thin TPU printing design layer as the outermost surface not only enables the application of durable, visually appealing decorative patterns but also adds a protective barrier that preserves the integrity of the underlying silicone and adhesive. This combination of features—medical-grade silicone adhesive and a TPU design layer—results in a facial tape product that is both functionally and aesthetically superior to existing solutions, addressing unmet needs in user comfort, skin safety, and product appeal.

The described concept further enhances previous approaches by utilizing the natural properties of silicone to offer a flexible, breathable, and biocompatible substrate that maintains skin tension in targeted areas. The adhesive backing is designed to adhere securely without leaving residue, while the decorative elements contribute to the product's appeal. Combined, these features provide a refined, user-oriented solution that addresses the technical challenges of overnight wrinkle management while improving the overall skincare experience.

The described technology encompasses various embodiments and alternatives to accommodate diverse user preferences and applications. For instance, the silicone facial tape may be offered in multiple shapes and sizes tailored to different facial anatomies, ensuring a comfortable and precise fit for a wide range of users. Additionally, the decorative patterns and designs can be customized to include various themes, colors, or textures, enhancing the aesthetic appeal and allowing users to select styles that align with their personal tastes.

Alternative embodiments may incorporate additional functional features, such as embedded skin-soothing agents like aloe vera or hyaluronic acid, which can provide supplementary skincare benefits during use. Furthermore, the adhesive properties of the tape can be adjusted to offer varying levels of adhesion, catering to users with sensitive skin or those requiring stronger hold. These embodiments and alternatives ensure that the described technology remains versatile, user-friendly, and adaptable to evolving consumer needs while maintaining its primary functionality of wrinkle reduction and skin smoothing.

The method of manufacturing the silicone facial tape involves several precise steps to ensure the product's functionality, comfort, and aesthetic appeal. First, medical-grade, skin-safe silicone sheets are selected for their flexibility, breathability, and suitability for prolonged skin contact. These sheets are then cut into pre-designed shapes tailored to fit wrinkle-prone areas, such as the forehead, under-eyes, and smile lines, using precision cutting tools like laser cutters or die-cutting machines. Decorative patterns or designs are applied to the silicone tape pieces using skin-safe inks or embedded printing techniques, ensuring the designs are durable and do not compromise the silicone's adhesive or flexible properties. The adhesive backing is formulated to adhere gently to the skin without causing irritation and is applied to the shaped silicone pieces. The completed tape pieces are then inspected for quality, ensuring uniformity in shape, design, and adhesive performance, before being packaged in hygienic, protective packaging that keeps the product clean and organized for user convenience. This method ensures the production of a high-quality, visually appealing, and effective wrinkle-reducing product.

The subject matter of the present disclosure uitilizes a medical-grade, pressure-sensitive silicone adhesive. Medical-grade pressure-sensitive silicone adhesives are specially formulated to provide gentle yet secure adhesion for applications involving direct and prolonged contact with human skin. These adhesives are designed to bond effectively when light pressure is applied, allowing for easy application and removal without causing irritation, redness, or damage to sensitive skin. Their hypoallergenic properties make them ideal for use in medical devices, wound dressings, and cosmetic products such as facial tapes, where user comfort and skin health are paramount. Medical-grade, pressure-sensitive silicone adhesives maintain their tackiness and adhesive strength over extended periods, even in the presence of moisture, sweat, or natural skin oils. They also peel away cleanly, leaving no sticky residue behind, which is essential for products intended for daily or overnight use. The combination of biocompatibility, flexibility, and reliable performance makes these adhesives particularly well-suited for innovative skincare solutions like the silicone facial tape described herein.

To use the silicone facial tape, the user begins by cleansing and drying the face to remove any dirt, oils, or makeup, ensuring a clean surface for effective adhesion. After applying their preferred overnight skincare products, such as serums or moisturizers, and allowing them to fully absorb, the user selects the pre-cut silicone tape pieces designed for targeted wrinkle-prone areas, such as the forehead, under-eyes, or smile lines. The tape is carefully removed from its hygienic packaging, avoiding excessive contact with the adhesive surface, and gently pressed onto the desired areas, smoothing out any wrinkles or creases. The tape remains in place overnight, providing consistent support to the skin and reducing creasing during sleep. In the morning, the user gently peels off the tape, taking care to avoid irritation, and proceeds with their regular skincare routine. To achieve noticeable results, the tape can be used regularly as part of a nightly regimen to encourage smoother, wrinkle-free skin over time.

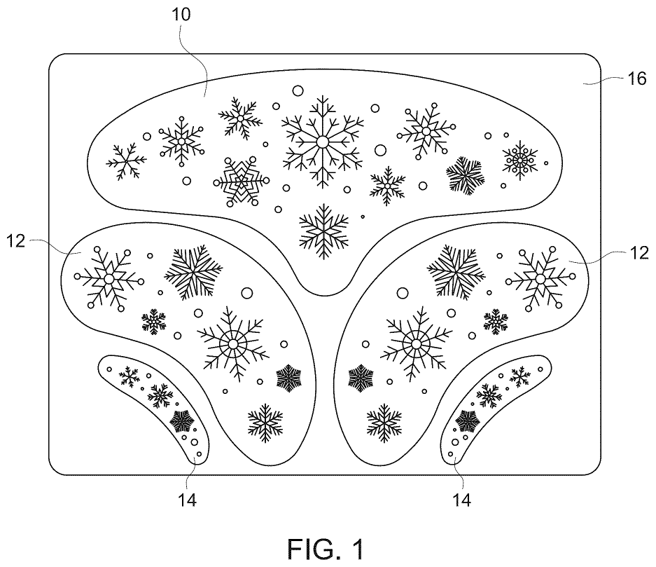

Referring to FIGS. 1-4, FIG. 1 illustrates the structural arrangement of the silicone facial tape set, which includes a forehead tape 10, under-eye tapes 12, and smile-line tapes 14. These tape pieces are pre-cut into shapes tailored for wrinkle-prone areas and are positioned on protective backing 16. The backing 16 serves to organize and protect the tape pieces, ensuring they remain clean and ready for application.

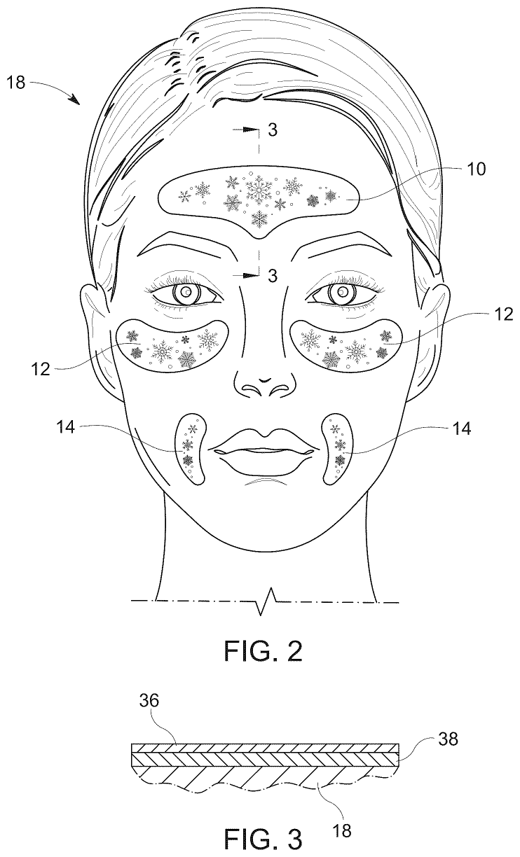

FIG. 2 demonstrates the placement of the silicone facial tape pieces of FIG. 1 on the user's face. In FIG. 2, the forehead tape is designed with an upper edge that is convex, approximately following the natural contour of the hairline to provide broad and secure coverage across the forehead. Extending downward from a central portion of the lower edge is a protrusion that reaches toward the bridge of the nose, effectively targeting the area between the eyebrows and addressing frown lines. On each side of this downward-extending protrusion, the lower edge forms concave curves that approximately mirror the arch of the eyebrow lines, allowing the tape to fit precisely and comfortably above the brows. All corners of the tape are smoothly rounded, ensuring gentle contact with the skin and minimizing the risk of irritation or lifting during use. The undereye tapes are shaped to conform to the anatomical contours beneath the eyes, providing targeted coverage for wrinkle-prone areas. Each tape features a concave upper edge that closely approximates the natural curve of the lower eyelid. The lower edge of the tape is convex, extending smoothly across the upper cheek to maximize skin contact and support. One end of the tape is narrower and gently curved, designed to sit adjacent to the nose and fit the inner corner of the undereye area. The opposite end is wider and also curved, positioned proximate to the ear to cover the outer undereye region and upper cheekbone. This asymmetrical, tapered design ensures a secure fit, effective wrinkle reduction, and a natural appearance when worn. All edges and corners are softly rounded to enhance comfort and minimize irritation during use. The smile line tape is positioned vertically on each side of the mouth, with its distinctive comma-like shape tailored to follow the natural curve of the nasolabial fold. The wider, rounded end of the tape corresponds to the region of the upper lip, providing broad coverage and gentle support to the area where smile lines are most prominent. The tape then tapers to a narrower, curved tip that extends downward toward the chin, allowing for precise application along the length of the crease. This vertical orientation and graduated width ensure that the tape effectively smooths and supports the skin in the smile line region, while all edges and corners remain softly rounded to maximize comfort and minimize irritation during overnight wear.

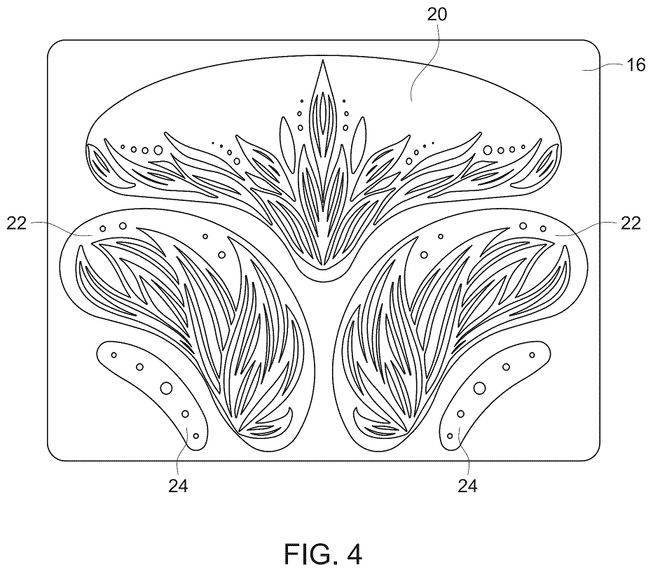

FIG. 3 illustrates the layered structure of the forehead tape 10. A thermoplastic polyurethane layer 36 is affixed to a user's 18 skin with a silicone gel adhesive layer 38.

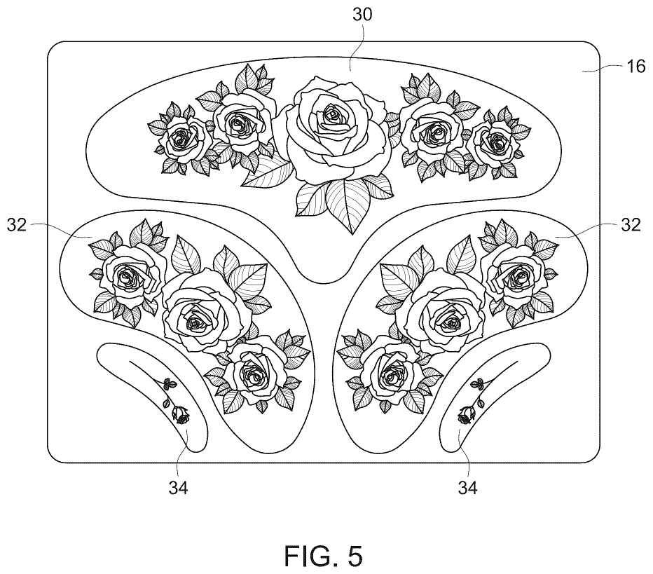

FIG. 4 depicts another decorative embodiment of the silicone facial tape set, featuring a decorative forehead tape 20, decorative under-eye tapes 22, and decorative smile-line tapes 24. FIG. 5 presents yet another decorative embodiment of the silicone facial tape set, including a decorative forehead tape 30, decorative under-eye tapes 32, and decorative smile-line tapes 34.

It should be understood, of course, that the foregoing relates to exemplary embodiments of the invention and that modifications may be made without departing from the spirit and scope of the invention as set forth in the following claims.

What is claimed is:

1. A silicone facial tape set comprising:
a plurality of tape pieces, each comprising a medical-grade, skin-safe thermoplastic polyurethane sheet pre-cut into at least one shape selected from the group consisting of a forehead piece, an under-eye piece, and a smile-line piece;
a medical-grade silicone adhesive backing disposed on a first surface of each tape piece, the medical-grade silicone adhesive backing being configured to adhere the tape pieces securely to facial skin overnight without causing irritation or leaving residue; and
a decorative pattern applied to a second surface of each tape piece.

2. The silicone facial tape set of claim 1, wherein the medical-grade silicone adhesive backing comprises a hypoallergenic, pressure-sensitive adhesive.

3. The silicone facial tape set of claim 1, wherein the medical-grade, skin-safe thermoplastic polyurethan sheet and/or the medical-grade silicone adhesive backing has a thickness ranging from about 0.2 mm to about 0.8 mm.

4. The silicone facial tape set of claim 1, further comprising packaging configured to organize and protect the tape pieces.

5. The silicone facial tape set of claim 1, wherein the medical-grade silicone adhesive backing is configured to maintain adhesion to facial skin for at least eight hours.

6. A method of manufacturing the silicone facial tape set of claim 1, comprising:
providing the medical-grade, skin-safe thermoplastic polyurethane sheet having first and second surfaces;
cutting the thermoplastic polyurethan sheet into a plurality of tape pieces, each pre-cut into at least the at least one shape;
applying the medical-grade silicone adhesive backing to the first surface of each tape piece, the medical-grade silicone adhesive backing comprising a hypoallergenic, pressure-sensitive adhesive;
forming a decorative pattern on the second surface of each tape piece; and
packaging the tape pieces in protective, hygienic packaging.

7. The method of claim 6, wherein forming a decorative pattern comprises screen-printing or embedded printing techniques.

8. The method of claim 6, further comprising inspecting each tape piece for uniformity in shape, adhesive coverage, and decorative pattern alignment prior to packaging.

9. The method of claim 6, wherein cutting the thermoplastic polyurethane sheet is performed using a precision cutting tool selected from the group consisting of a laser cutter and a die-cutting machine.
